(19) United States
(12) Patent Application Publication
(10) Pub. No.: US 2014/0199504 A1
(43) Pub. Date: Jul. 17, 2014

(54) SYSTEM AND METHODS FOR CREATING WRAPPED FILAMENT REINFORCED VESSELS, AND VESSELS CREATED THEREBY

(71) Applicants: Joseph W. Anderson, Redmond, WA (US); Leigh C. Anderson, Hood River, OR (US)

(72) Inventors: Joseph W. Anderson, Redmond, WA (US); Leigh C. Anderson, Hood River, OR (US)

(21) Appl. No.: 14/155,932

(22) Filed: Jan. 15, 2014

Related U.S. Application Data
(60) Provisional application No. 61/753,827, filed on Jan. 17, 2013.

(51) Int. Cl. B29C 53/56

(52) U.S. Cl. CPC B29C 53/56
USPC 428/34.1; 156/169; 156/433

(57) ABSTRACT

A manufacturing apparatus for producing filament-wound products such as pressure vessels and pipes includes a mandrel for supporting a pre-form vessel, a mandrel driver structured to rotate the pre-form vessel, and an array of individual filament supports for guiding individual filaments used in producing the vessel. Using the unique aspects of the apparatus which avoids the customary high-angle fiber crossings significantly speeds up manufacturing and thus lowers product cost, increases product lifetime, reduces fatigue stress, and reduces weight of the finished product. Methods of production are also disclosed.

### FIELD OF THE INVENTION

This disclosure is directed to a system and methods for producing vessels, and, more particularly, to a system and methods for producing vessels by filament winding, as well as to the vessels created by such a system and methods.

### BACKGROUND

Filament-wound products such as composite pressure vessels and piping are used where light weight, corrosion resistance, and/or other high-performance needs exist. These pressure vessels are commonly used for storing compressed air or oxygen for breathing bottles, such as for firefighters and scuba divers. They also find use for storing other compressed gasses such as compressed natural gas (CNG) tanks for vehicles, for aerospace applications, and for many other uses. Although the words ‘vessel’ or ‘tank’ are used in the following discussions, it should be understood that embodiments of the invention may extend to filament wrapped pipes and other product containers as well.

Conventional composite pressure vessels are manufactured by various methods, such as filament winding, hand layup, fiber-placement, or using braided or knitted preforms. The windings are usually applied over a rotatable mandrel, form, or a liner that may be left in place during fabrication and retained in the finished product. The filaments themselves may be made from strands of carbon fiber or carbon matrix, or other high-tensile strength materials, and provide much of the strength of the container. Resins and hardeners may be applied to the filaments either before or after wrapping. Resins and/or hardeners may be of thermoplastic or thermoset type.

In practice, knitted reinforcements are little-used since the strength of the fibers degrades during the formation process of winding the fibers onto bobbins and unwinding them back off again. Also, the fibers in the knitted preform itself cross each other at such severe angles and directions that it limits their fatigue strength and thus the usable life-span of the vessel. Further, the knitting machines themselves are subject to speed limitations by the very nature of the complex paths the bobbins must take. Finally, the cost of such vessels made my knitted reinforcements tends to be relatively high, and therefore disfavored.

Hand laid-up vessels utilize various combinations of pre-made random fiber mats, rovings, woven rovings, woven cloths, uni- , bi- and tri-axial cloths and other materials. Generally, the material is laid onto a mandrel, form, or a liner by hand or by a manually guided process. This process is suitable only for manufacture of complex or low production rate vessels where more automated methods are not suitable. In general, costs are too high for high production vessels, especially those of simple geometry. Fiberglass is sometimes used for these applications.

Filament winding is the most common method of pressure vessel manufacturing. The winding process may be manually or automatically controlled, with the latter predominating. There are many established manufacturers of filament winding machines, most of whom offer Numerically Controlled (NC) machines.

Generally, as illustrated in FIGS. 1A-1D, a standard filament winding machine includes a stationary bed and a traveling carriage to guide a band of filaments 10, and a rotating mandrel, which holds a pre-form or liner 12 upon which the windings will be applied. The head travels back and forth along the axis of rotation of the mandrel, and the mandrel is rotated to continuously spin the vessel in the same direction while the vessel is being produced. The ratio of longitudinal movement of the traveling head laying the band of fibers 10 to the speed of rotation of the mandrel is used to control the angle of the windings as well as a pitch P, as illustrated in FIG. 1A. On NC winders, the pattern may even be programmed to wrap around features on the vessel, such as bosses or openings. The characteristic checkerboard-like cylindrical pattern of the windings is generated as the head travels back and forth, winding a small percentage of the vessel at a time with the mandrel always rotating in the same direction, as illustrated in FIGS. 1A and 1B. The overlapping areas 20 in the pattern cause loss of fatigue strength in areas where the edges of the fiber bands 10 wear against each other at large angles, typically about 75 degrees, as illustrated in FIG. 1B. Having more overlapping areas 20 also increases the weight of the vessel since more filament material must be used to make up for the loss of strength in the overlapping areas. Generally, the width W of the band of fibers 10 being wrapped is limited to less than 10% of the vessel circumference. The width of the fiber band 10 is purposely minimized to decrease the fatigue factor. Attainable fiber wrapping velocities are also limited by centrifugal forces, fiber tension, resin flow requirements, and other considerations. The width of the fiber band 10 is also physically limited because the fibers of the band 10 that are leading as the carriage moves in a first direction become the trailing fibers of the band when the carriage direction is reversed. If the band 10 is too wide, an active tension must be employed to maintain control of the fiber control during the reversal, which is difficult to control.

Various methods of automated filament winding may be employed, such as helical winding illustrated in FIGD. 1A and 1B, hoop winding as illustrated in FIG. 1C, and polar winding as illustrated in FIG. 1D.

Hoop winding is a high angle helical winding where an angle of the band fibers 10 approaches an angle of nearly 90 degrees to the longitudinal axis of the vessel. The head advances along the vessel axis by one fiber band 10 width per mandrel revolution, as illustrated in FIG. 1C.

In polar winding, illustrated in FIG. 1D, a mandrel arm spins as the pre-form 12 rotates on the mandrel, all while the fibers of the band 10 pass tangentially to a polar opening 18 at one end of the vessel chamber, then pass tangentially to the opposite side of the polar opening at the other end. In other words, the band of fibers 10 are wrapped from pole to pole, as the mandrel arm rotates about the longitudinal axis as shown in FIG. 1D. Polar winding is used to wind almost axial fibers on domed end type of pressure vessels. On vessels having parallel sides, a subsequent circumferential winding may also be performed to reinforce the flat sided portion.

Of these winding methods, helical winding has the most versatility, as almost any combination of diameter and length may be wound by trading off winding angle, number of passes and width of band to close the patterns. The majority of filament reinforced composite tubes and pressure vessels are currently produced by helical winding.

A problem exists in all of these winding methods, however, to varying degrees depending on the winding method used. A significant problem with the helical winding method is that the end product contains several severe fiber crossing and bending, which weakens the individual fibers and consequently the vessels. This means that pressure vessels weaken with every pressure/vent cycle as the fibers are expanded and contracted over one another. Further, none of the present winding methods allows a minimum number of fibers to be used in creating vessels because extra layers and windings must be made to provide the vessels with sufficient strength to meet their safety and use requirements. The end products are also heavier and costlier as a result.

Embodiments of the invention address these and other issues in the prior art.

### SUMMARY OF THE DISCLOSURE

Embodiments of the invention are directed to a manufacturing apparatus for filament-wound products such as pressure vessels and pipes that use a number of individual fibers, strands, or filaments arranged in the apparatus to create the vessel. The filaments are wound around the vessel separately, in concert, as the vessel spins in a first direction as the vessel moves longitudinally past the filament arrangement. In this manner the entire circumference and length of the vessel is covered with layers of filaments all laying in the same direction in each layer. After reaching the end of the vessel, the vessel is spun again, in the opposite direction of rotation, as the vessel again moves longitudinally past the filament arrangement to lay down a next layer of filaments. The vessel may change spinning directions after each longitudinal stroke. Additionally, the filaments may be cut, tied or otherwise secured at the end of each longitudinal stroke. After sufficient filaments or layers of filaments have been deposited, the filaments are cut. Then the vessel may be removed from the manufacturing apparatus. Several variations exist. For example, in some embodiments the vessel moves longitudinally past a static filament arrangement, while in other embodiments it is the filament arrangement that moves longitudinally past a static vessel. In some embodiments both the vessel and the filament arrangement may move.

The manufacturing method using the inventive apparatus allows that a high percentage, up to 100% of the circumference, of the vessel may be wound at the same time in a massively-parallel way; greatly increasing the rate at which the filament can be applied to the vessel within the speed limitations for filament winding. The method also avoids the stress of high-angle filament crossings, thus having positive benefits for the vessels' cost, life span, safety, and weight.

### BRIEF DESCRIPTION OF THE DRAWINGS

FIGS. 1A and 1B are diagrams of conventional helical winding methods of producing a pressure vessel.

FIG. 1C is a diagram illustrating a conventional hoop winding method of producing a pressure vessel.

FIG. 1D is a diagram illustrating a conventional polar winding method of producing a pressure vessel.

FIG. 2A is a side view of a system for creating wrapped-filament reinforced vessels using a multitude of non-banded fibers or filaments according to embodiments of the invention.

FIG. 2B is a top view of the system of FIG. 2A.

FIG. 3 is a side view of the system of FIG. 2A at a first tie-off stage, according to embodiments.

FIG. 4 is a partial detailed view of the tie-off portion of the vessel illustrated in FIG. 2A according to embodiments.

FIG. 5 is a side view of the system of FIG. 2A at a completion of a first wrap stage, according to embodiments.

FIG. 6 is a side view of the system of FIG. 2A at a completion of a second tie-off stage, according to embodiments.

FIG. 7 is a side view of the system of FIG. 2A at a completion of a second wrap stage, according to embodiments.

FIG. 8 is a side view of the system of FIG. 2A at a completion of a third tie-off stage, and iterative wrapping, according to embodiments.

FIG. 9 is a side view of the system of FIG. 2A at a completion of a final tie-off stage, according to embodiments.

FIG. 10 is a side view of the system of FIG. 2A at a completion of a final cut-off stage, according to embodiments.

FIG. 11 is a side view of the system of FIG. 2A at a completion of production, where the vessel is complete and ready for removal, according to embodiments.

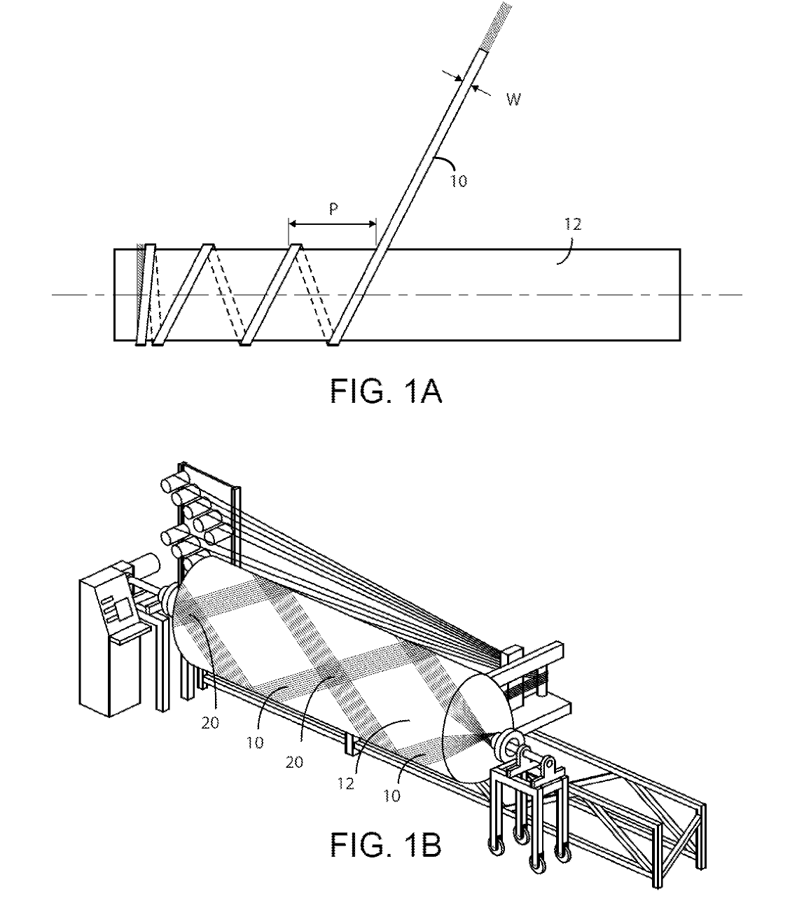

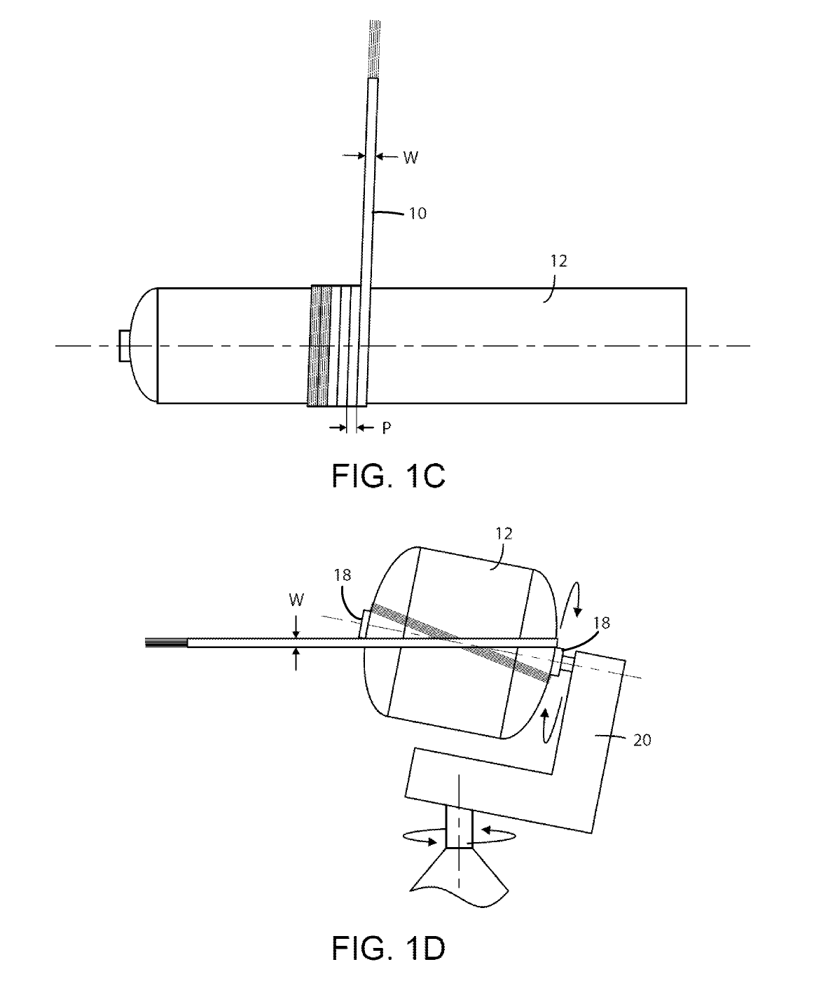

### DETAILED DESCRIPTION

As described herein, embodiments of the invention are directed to a manufacturing apparatus for filament-wound products such as pressure vessels and pipes, that significantly speeds up manufacturing and thus lowers product cost, increases product lifetime, reduces fatigue stress, and reduces weight of the finished product. These benefits are obtained by a novel combination of counter-rotation, tie-off and cutting mechanisms, tie-off retaining geometries of the form/liner, massively-parallel winding and avoidance of filament stress points typical in conventional helical winding methods.

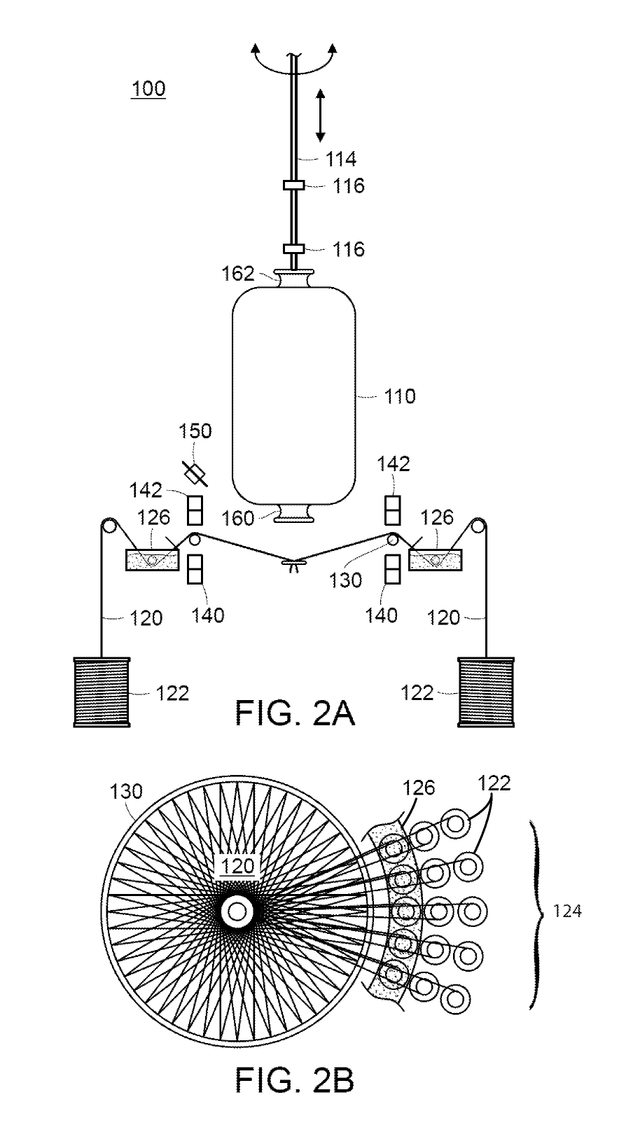

FIG. 2A is a side view of an example system 100 for creating wrapped-filament reinforced vessels using a multitude of non-banded fibers or filaments according to embodiments of the invention. In FIG. 2A, a vessel 110 is coupled to a rotatable and slideable shaft 114, which may also include rotating and sliding bearings 116. The vessel 110 may initially be formed as a pre-form or may be formed around what will end up as a liner when the vessel is manufactured. In this disclosure, the term vessel may refer to such a pre-form, line, or completed vessel depending on context. The vessel 110 may be rotated about the shaft 114 in one direction, for example clockwise, or in two directions, such as clockwise and counter-clockwise, depending on the desired forming method.

Wrapping strands, fibers, or filaments 120 may be arranged in an array 124 or group at one or more sides of the vessel 110, as illustrated in an example top view FIG. 2B. Such a massively parallel arrangement allows the vessel 110 to be created with many filaments 120 being applied simultaneously to the vessel pulled from filament spools 122. The number of individual filaments 120 in the array 124 may be selected depending on the needs of the vessel 110 being produced or of the system 100. In some embodiments, there may be a modest number of individual filaments so arranged, such as between 3 and 80. In other embodiments, there may be hundreds or even thousands of individual filaments in the array 124. Each filament may originate in a filament spool 122.

One or more of the filaments 120 may first pass through a resin wet bath 126, which may contain a liquid binder for holding the filaments in place as they are placed on the vessel 110. The resin bath 126 may also include hardeners or other compounds used in curing the finished vessel. In some embodiments, the filaments 120 are pre-impregnated with curing material (prepreg), or the curing material may be applied to the filaments at a later time. In these situations, the resin bath 126 therefore may be omitted.

After passing through the resin bath 126, the filaments 120 of the array 124 may negotiate past a guide, such as a guide ring 130, which directs the particular filament strands onto the vessel 110. In some embodiments, each filament 120 includes a separate guide ring 130, while in other embodiments more than one filament may share a guide ring. The collection of guide rings 130 at least partially surrounds the system 100 to align the filaments as they approach the vessel 110.

Cutting and tie-off mechanisms, which may include both lower tie offs 140 and upper tie offs 142, are also depicted. Such tie-off mechanisms 140, 142, enable a counter-rotation, whole-body production method as described in detail below. One or more strand cut-off mechanisms 150 are also preferably included so that the finished vessel 110 may be removed after being produced.

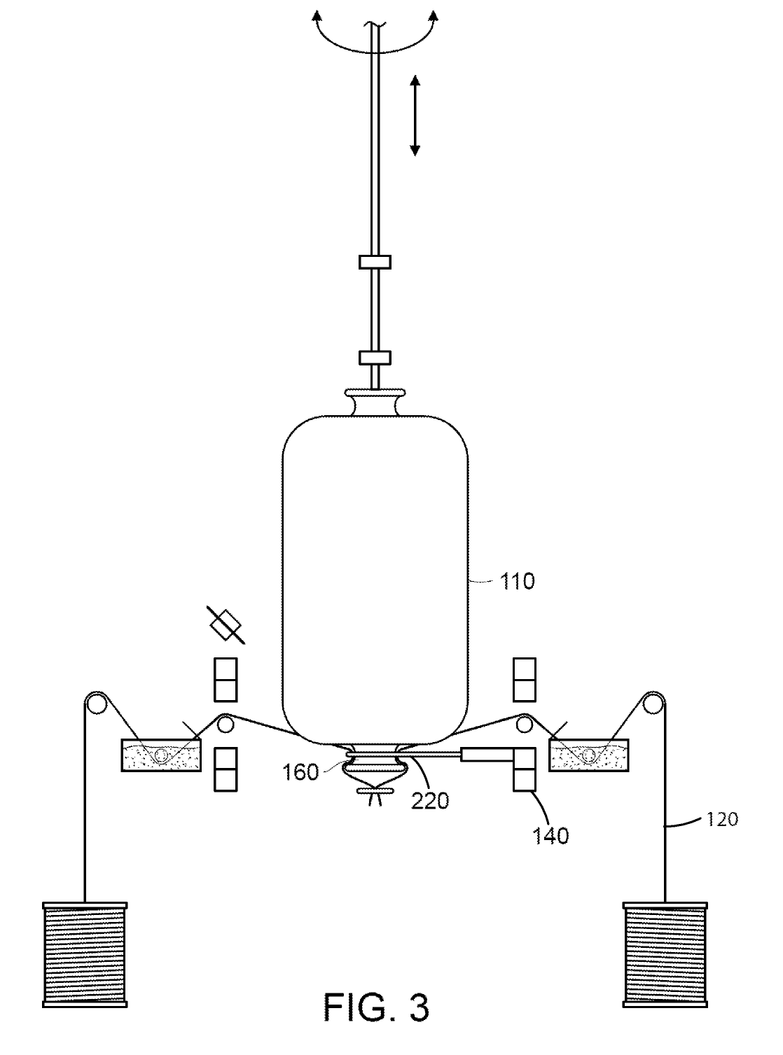

FIG. 3 is a side view of the system of FIG. 2A illustrating its state at a first tie-off stage, according to embodiments. As a first step in the production process, the vessel 110 is lowered or translated into a tie-off position. In some embodiments the vessel 110 moves past a stationary array 124 of filaments 120 (FIG. 2B), while in other embodiments the vessel 110 is stationary.

A first end of the vessel 110 includes a projection or groove 160, while a second end of the vessel 110 may also include a projection or groove 162. During a first tie-off process, the groove 160, which is most adjacent to the lower tie-off mechanism 140, accepts tie off strands 220, or other clamping materials, from the tie-off mechanism 140 to securely attach the filaments 120 to the vessel 110 in the area of the projection or groove 160. A first tie-off preferably takes place before the winding of the filaments 120 around the vessel 110. The first tie-off may occur before or after the vessel 110 begins to rotate.

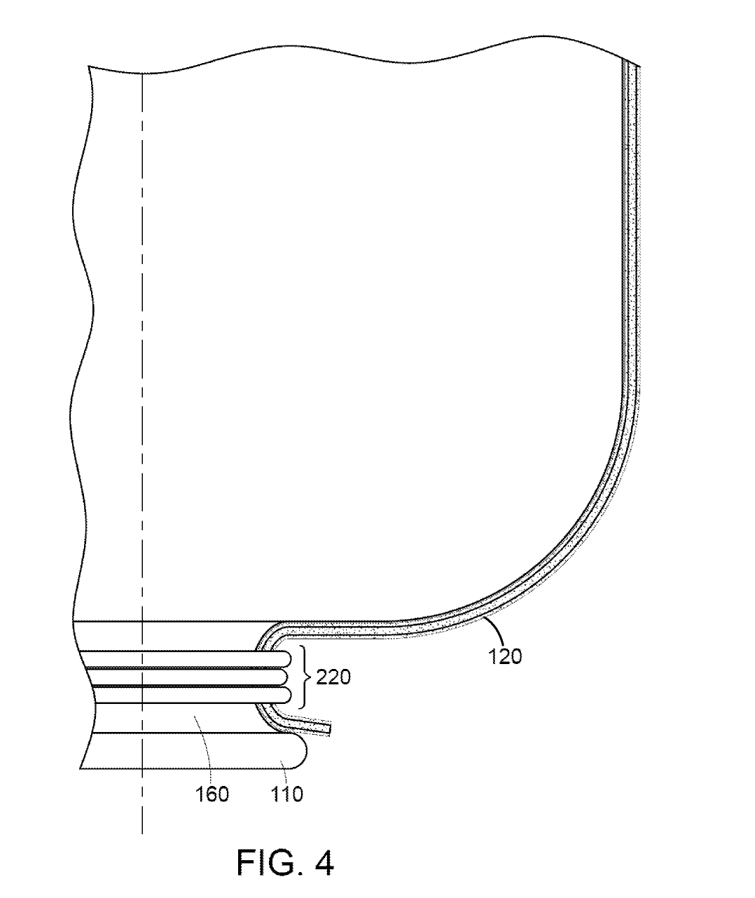

FIG. 4 is a detailed view of the tie-off portion of the vessel illustrated in FIG. 2A according to embodiments. In FIG. 4, the tie-off strands 220 are illustrated as wrapped around or otherwise secured within the groove 160. As described above, the tie-off strands 220 secure the filaments 120 to the vessel 110.

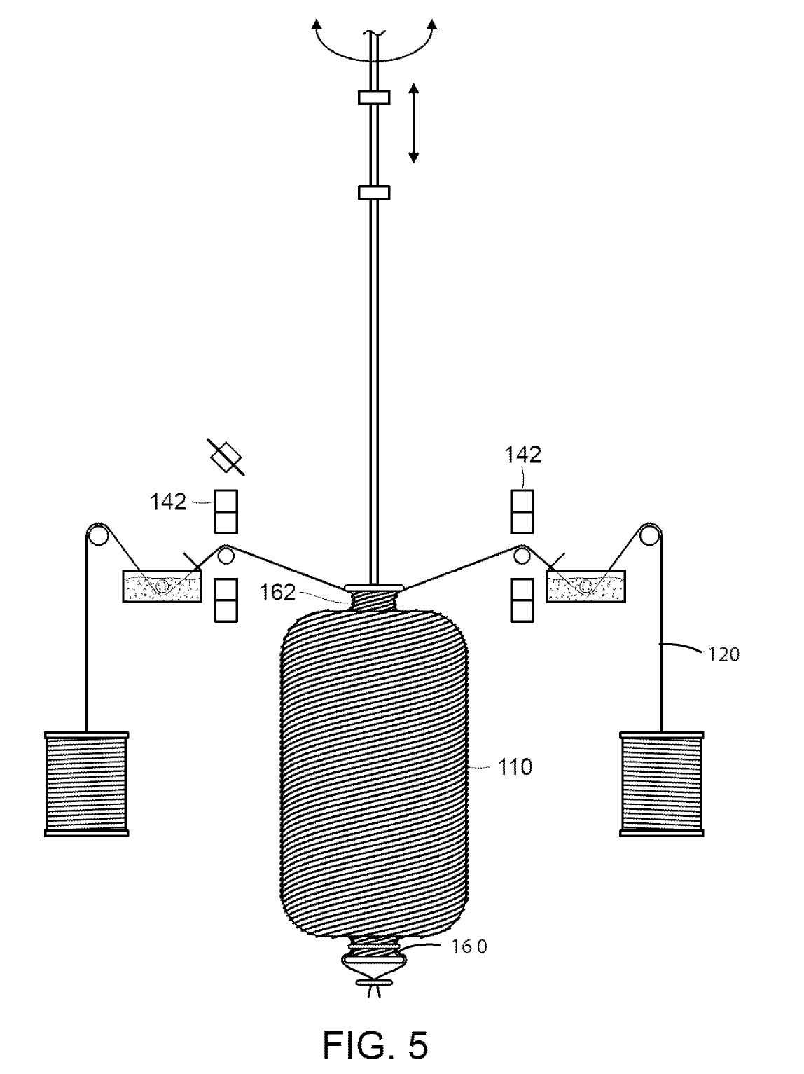

FIG. 5 is a side view of the system of FIG. 2A at a completion of a first wrap stage or wrap pass, according to embodiments. After the filaments 120 are initially secured to the vessel 110, the vessel is rotated in a first direction as it moves past the array 124 of filaments 120. Such action causes the filaments 120 to wind around the vessel 110 in a wrapping motion. The filaments 120 are laid down in a single layer of the entire vessel 110 during the first wrap stage. The application of filaments 120 to the vessel 110 is made at a coordinated rate of translation and wrapping rotation speed of the vessel to achieve the desired helical wrap angle. In one embodiment the wrap angle is approximately 37.5 degrees. In other embodiments the wrap angle is anywhere between approximately 20 and 50 degrees. The entire surface of the vessel 110 is covered in one wrap pass. The translation motion stops the vessel 110 when the upper tie off mechanism 142 is adjacent to the second projection or groove 162, located at the opposite side of the vessel 110 from the first groove 160, just prior to a second tie-off. The rotation of the vessel 110 is also stopped just prior to tie-off.

With respect to each wrap stage, the number of filaments 120 in the array 124 dictates how quickly the vessel can be created, and how many rotations of the vessel are necessary.

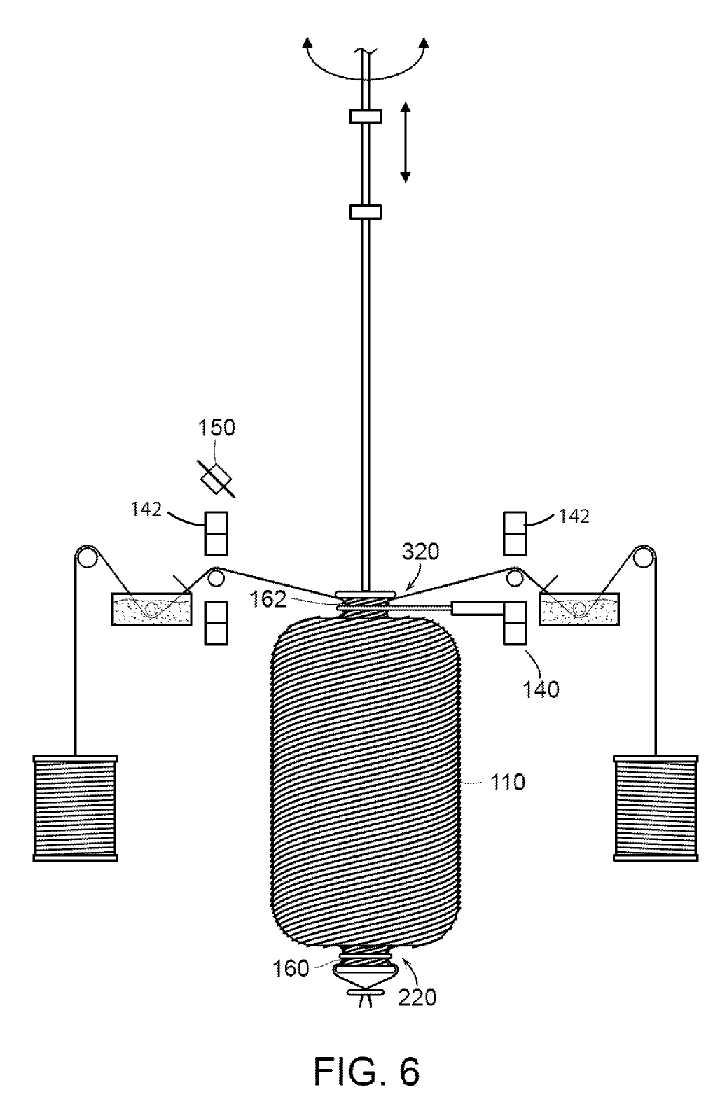

FIG. 6 is a side view of the system of FIG. 2A at a completion of a second tie-off stage, according to embodiments. This illustration shows the process just after the first wrapping pass is complete and the vessel 110 is static. It shows the lower tie-off mechanism 140 wrapping and then the cut-off mechanism 150 cutting the tie-off strands around the groove 160 to accomplish the second tie-off 320.

After the second tie-off 320 is complete, the vessel 110 is ready to be wrapped with a second layer of filaments 120. As the second wrapping pass starts, recall that the filaments 120 are secured at the other groove 162 by the second tie-off. In preferred embodiments of the invention, during the second wrapping pass, the vessel 110 rotates in an opposite direction to the direction the vessel had rotated during the first wrapping pass.

Thus, during the second wrapping pass, the filaments 120 do not cross, at high angles, the filaments laid on the vessel during the first wrapping pass. Instead, the filaments 120 applied during the second wrapping pass lie smoothly over the filaments applied during the first wrapping pass.

This arrangement allows the vessel 110 to be made without high-angle, filament cross-overs and thus avoid the filament fatigue stress during pressurization/depressurization cycling of the pressure vessel.

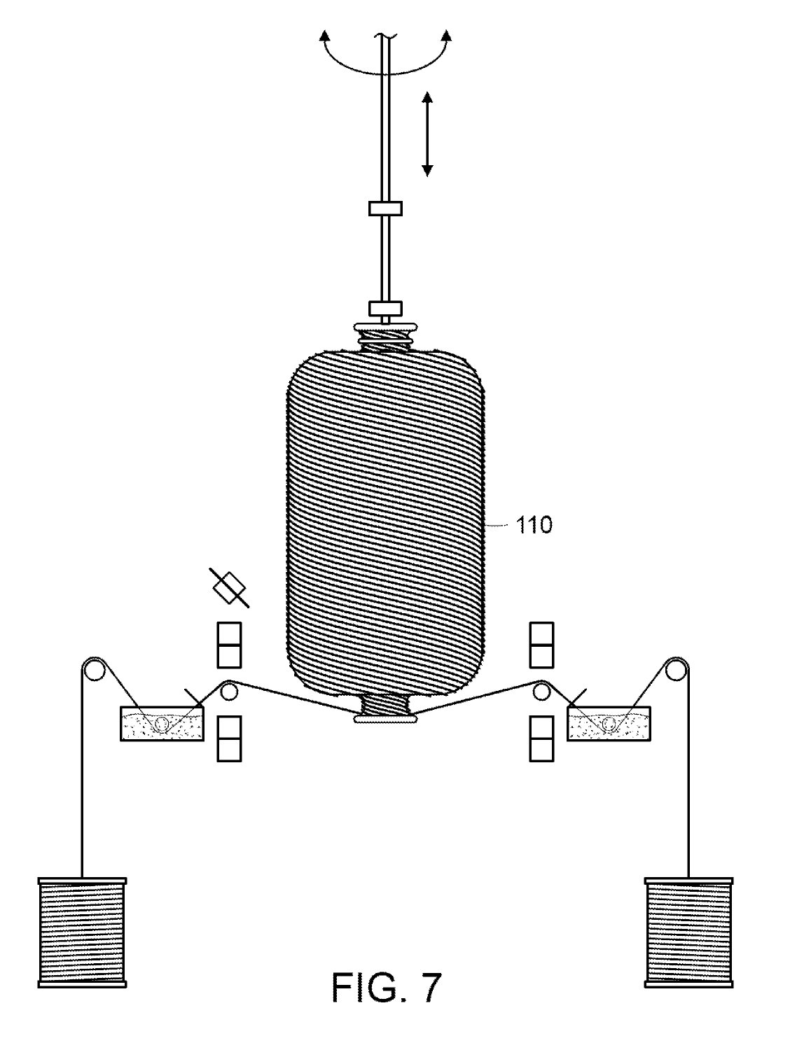

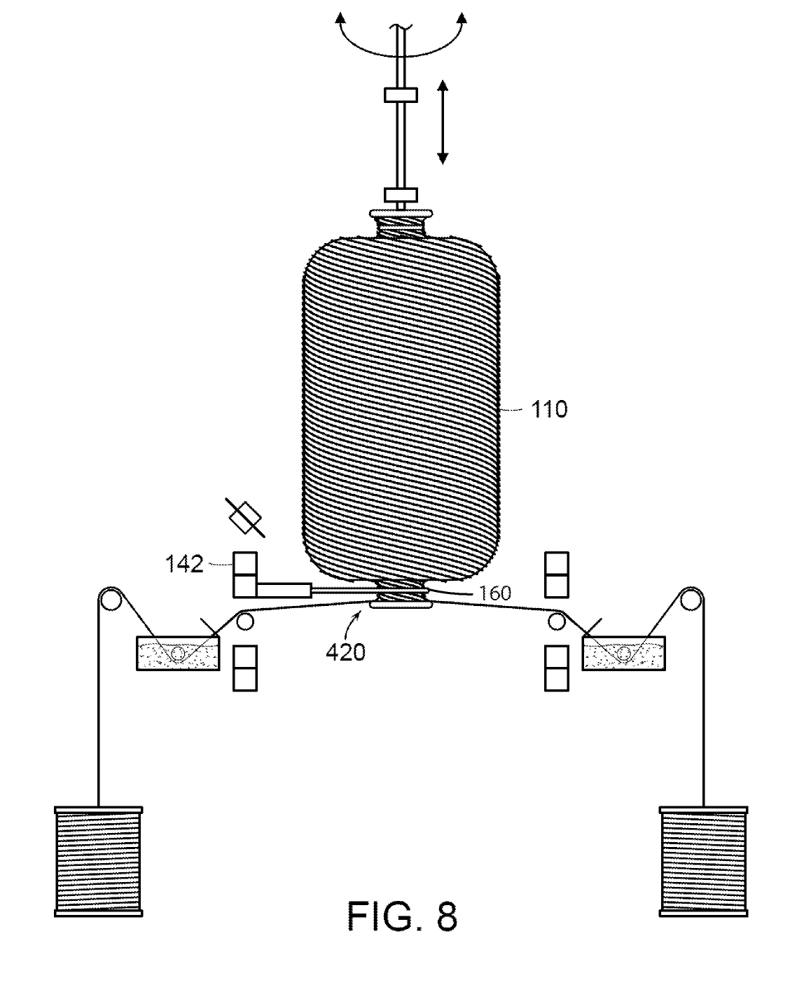

FIG. 7 is a side view of the system of FIG. 2A at a completion of this second wrap stage, according to embodiments, while FIG. 8 shows the system after a third tie-off.

After the second wrapping pass has been completed, a third tie off 420 is made. The third tie off is made at the same groove 160 as the first tie off, and made in the same or a similar manner.

At this stage, the processes of applying filaments 120 in a wrapping stage followed by tie off at the particular projection or groove 160, 162 may be iteratively repeated until a desired number of wraps or layers of the filaments is complete. Recall that to preserve the feature that filaments 120 do not significantly cross one another at steep angles in the ultimately produced vessel 110, the vessel rotates in an opposite direction at the conclusion of each wrapping and tying pass.

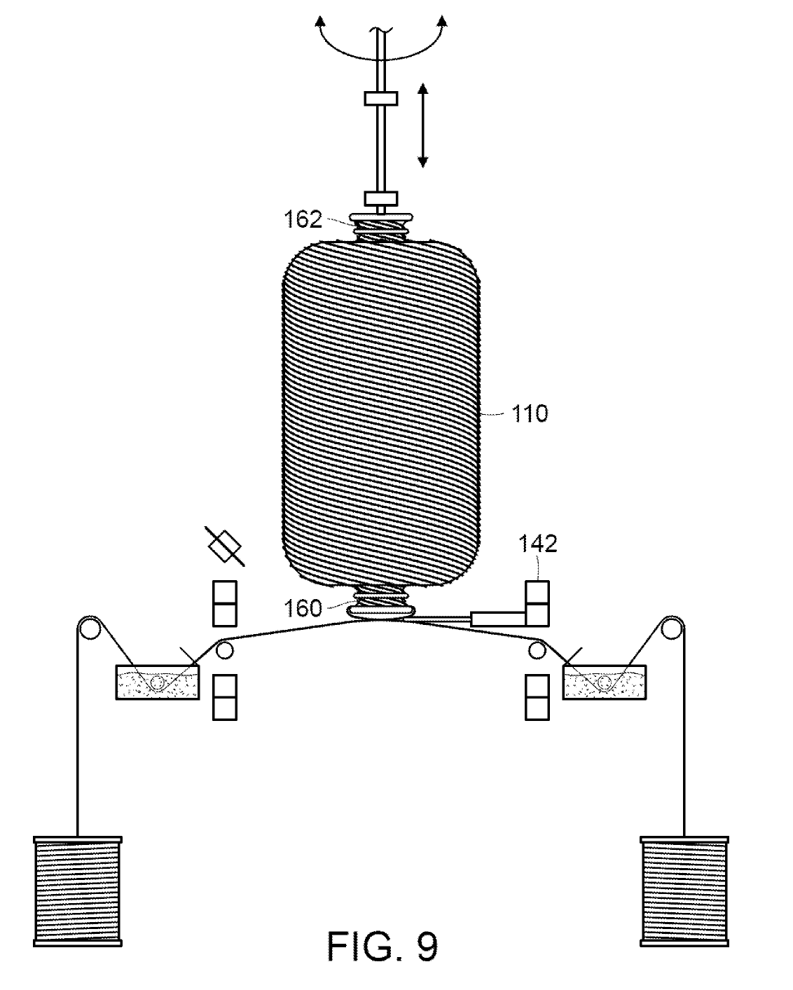

FIG. 9 is a side view of the system of FIG. 2A at a completion of a final tie-off stage, according to embodiments. Similar to the first and third tie-offs being located at the groove 160, described above, the second and fourth tie-offs are both made in a similar fashion and similarly located at the projection or groove 162.

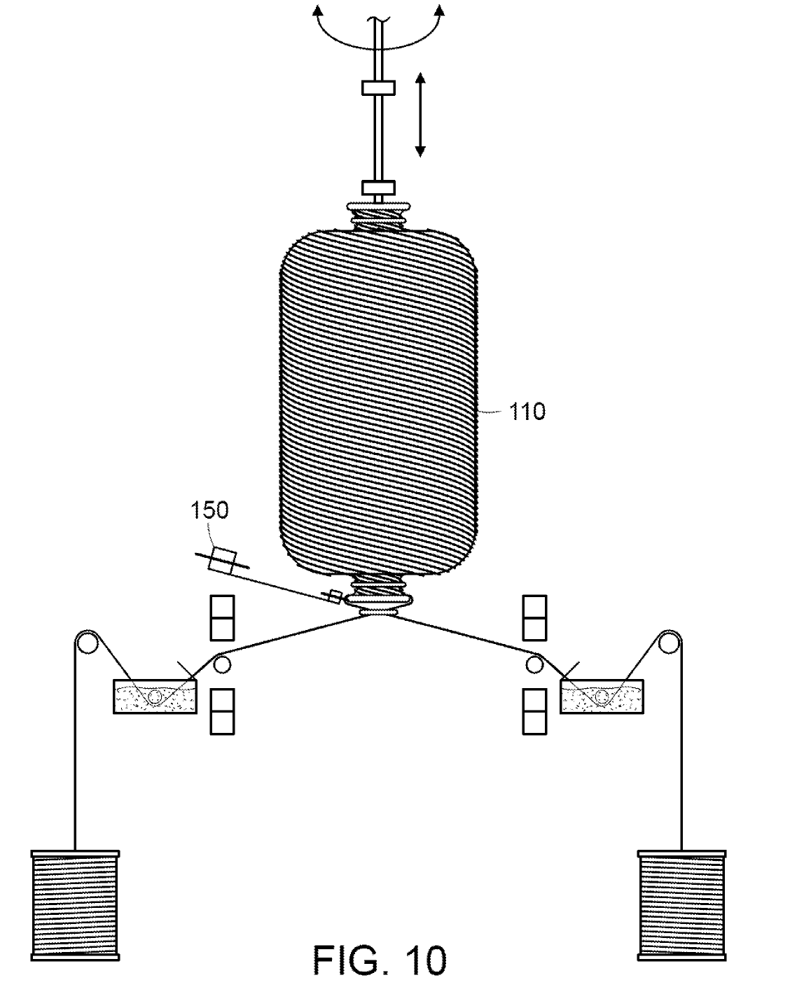

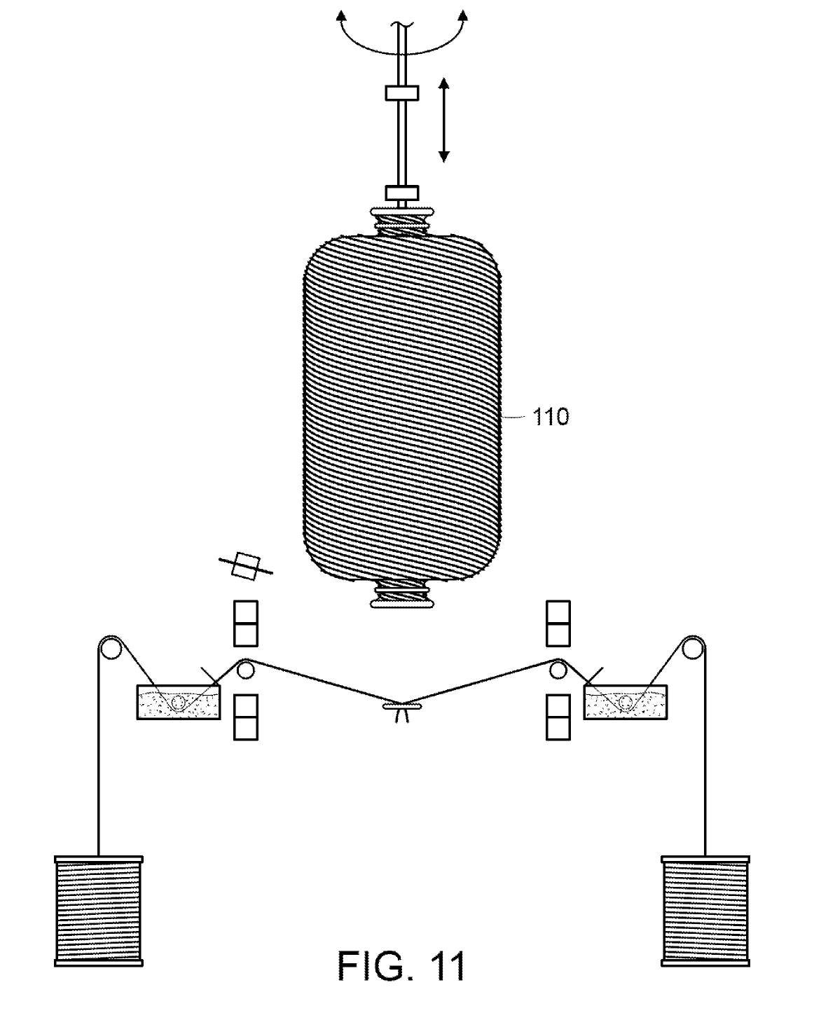

After the desired number of winding passes have been made to achieve the vessel's functional specifications, and after the final tie-off has been made, the strand cut off 150 (FIG. 2A) operates to sever all of the filaments from the vessel, as illustrated in FIG. 10. The final cut-off may be made at either end. Then, as illustrated in FIG. 11, the completed vessel 110 is finished and may be removed from the creation system 100.

As described above, vessels made in accordance with embodiments of the invention are made from wound strands that do not cross one another at severe angles, hence fiber fatigue is reduced or eliminated. This gives the created pressure vessels a longer, safer, lifetime with increased strength compared to those made with previous systems and according to previous methods.

Another benefit is that, by increasing the strength of the vessels, the vessels may be made from less material compared to similar conventional vessels, which allows them to be used with less human effort, such as self-contained breathing apparatus (SCBA) used by firefighters, divers, and others who manually carry the vessels. Additionally, vessels used for vehicles may make the vehicles more efficient regarding fuel consumption, due to the lighter overall weight while providing the same strength.

Other benefits gained by using embodiments of this invention include a significant manufacturing cost-reduction through a much faster, massively-parallel application mechanism for the filament reinforcements while also improving the fatigue strength and longevity of the vessel so formed.

Other variations of the system and method to produce the pressure vessels include using a larger assembly line or carousel of multiple stations prior to and after the whole-body-filament-winding station. For instance other stations may include a station for loading of liners containing projections, a station for curing, optional projection removal, machining, installation of valves or caps, optional painting or coating, and finally an automated removal method to remove the finished product from the carousel or assembly line.

Although specific embodiments of the invention have been illustrated and described for purposes if illustration, it will be understood that various modifications may be made without departing from the spirit and scope of the invention. Accordingly, the invention should not be limited except as by the appended claims.

What is claimed is:

1. A method for manufacturing a filament-wound vessel, the method comprising:
placing a vessel form on a mandrel;
positioning a first end of the vessel form near an array of individual filaments;
securing the array of filaments at a first end of the vessel form;
rotating the vessel form about an axis of the mandrel in a first direction while simultaneously moving the first end of the vessel form away from the array of individual filaments to produce the vessel from filaments overlaying the vessel form, the vessel having all of the filaments of a single filament layer laying substantially in the same direction covering a complete length of the vessel.

2. The method of claim 1, further comprising:
securing the filaments at a second end of the vessel form.

3. The method of claim 2, further comprising:
rotating the vessel form about the axis of the mandrel in a second direction while simultaneously moving the first end of the vessel form toward the array of individual filaments to form a second layer of filaments, the second layer of filaments laying substantially in the same direction as the first filament layer.

4. The method of claim 1 wherein the filaments are applied around an entire circumference and length of the vessel all in one operation.

5. The method of claim 2 wherein securing the filaments at either the first end or the second end comprises securing the filaments while rotating the vessel form.

6. The method of claim 2 wherein securing the filaments at the second end of the vessel comprises:
securing the filaments while rotating the vessel form in a second direction.

7. The method of claim 2, wherein securing the filaments comprises:
wrapping a securing line filament around the filaments at the second end of the vessel.

8. The method of claim 1 wherein the securing the filaments at the first end comprises securing the filaments at a groove at the first end of the vessel form.

9. The method of claim 1 wherein the securing the filaments at the first end comprises securing the filaments at a projection at the first end of the vessel form.

10. The method of claim 9, further comprising removing the projection after a final filament layer has been formed.

11. The method of claim 1, further comprising:
wetting the filaments with resin prior to wrapping.

12. The method of claim 1, wherein the individual filaments are pre-impregnated with a resin before wrapping.

13. The method of claim 1, further comprising:
applying resin to the vessel after the wrapping is complete.

14. A vessel made by performing the process of:
placing a vessel form on a mandrel;
positioning a first end of the vessel form near an array of individual filaments;
securing the array of filaments at a first end of the vessel form;
rotating the vessel form about an axis of the mandrel in a first direction while simultaneously moving the first end of the vessel form away from the array of individual filaments to produce the vessel from filaments overlaying the vessel form, the vessel having all of the filaments of a single filament layer laying substantially in the same direction covering a complete length of the vessel.

15. An apparatus for manufacturing a vessel, comprising:
a mandrel for supporting a pre-form vessel;
an array of individual filament supports for respective individual filaments; and
a mandrel driver structured to rotate the mandrel and pre-form vessel in a first direction during a first wrapping pass, and structured to rotate the mandrel and pre-form vessel in a second direction during a second wrapping pass.

16. The apparatus for manufacturing a vessel according to claim 15, further comprising means for moving the pre-form vessel relative to the array of individual filament supports.

17. The apparatus for manufacturing a vessel according to claim 16 in which the means for moving the pre-form vessel relative to the array of individual filament supports is the mandrel.

18. The apparatus for manufacturing a vessel according to claim 15, further comprising a filament tie-off portion structured to secure the individual filaments carried by the individual filament supports to the pre-form vessel.

19. The apparatus for manufacturing a vessel according to claim 15, further comprising a resin reservoir through which individual filaments that are carried by the individual filament supports are conveyed prior to being applied to the pre-form vessel.
